(19) United States
(12) Patent Application Publication
(10) Pub. No.: US 2020/0168860 A1
(43) Pub. Date: May 28, 2020

(54) ENERGY STORAGE DEVICE AND ENERGY STORAGE MODULE

(71) Applicants: Robert Bosch GmbH, Stuttgart (DE); GS Yuasa International Ltd., Kyoto-shi (JP)

(72) Inventors: Yukio ENOMOTO, Kyoto-shi, Kyoto (JP); Hironori KAWANISHI, Kyoto-shi, Kyoto (JP)

(21) Appl. No.: 16/637,223

(22) PCT Filed: Oct. 16, 2018
(86) PCT No.: PCT/EP2018/078263

§ 371 Date: Feb. 6, 2020

(30) Foreign Application Priority Data
Oct. 17, 2017 (JP) 2017-201206

(51) Int. Cl. H01M 2/06; H01G 11/30; H01G 11/78; H01G 11/74; H01M 2/24; H02G 5/02; H01M 2/30

(52) U.S. Cl. CPC H01M 2/06; H01G 11/30; H01G 11/78; H01M 2/30; H01M 2/24; H02G 5/02; H01G 11/74

(57) ABSTRACT

An energy storage device and the energy storage module include: an outer case on which an external terminal is mounted; an electrode assembly housed in the outer case; a conductive shaft portion having one end thereof connected to the external terminal; and a conductive plate portion housed in the outer case, to which the other end of the conductive shaft portion is connected, and the electrode assembly is connected. A recessed portion is formed on a first surface of the external terminal on which a bus bar is placed, and a second surface of the external terminal opposedly faces the outer case. One end of the conductive shaft portion is brought into pressure contact with the external terminal in the inside of the recessed portion. The recessed portion formed on the external terminal is gas-tightly covered by the bus bar.

### TECHNICAL FIELD

The present invention relates to an energy storage device, and an energy storage module.

### BACKGROUND ART

A chargeable and dischargeable energy storage device is used in various equipment such as a mobile phone and an automobile. A vehicle which uses electric energy as a power source such as an electric vehicle (EV) or a plug-in hybrid electric vehicle (PHEV) requires large energy. Accordingly, an energy storage module of a large capacity which includes a plurality of energy storage devices is mounted on the vehicle.

In general, an energy storage device is configured such that an electrode assembly formed by stacking or winding a positive electrode plate and a negative electrode plate with a separator interposed between the positive electrode plate and the negative electrode plate is gas-tightly housed in a case together with an electrolyte solution. A positive electrode external terminal and a negative electrode external terminal electrically connected to the electrode assembly via current collectors are mounted on a lid plate of the case. A gasket or an insulation plate is disposed between the case and the terminal and between the case and the current collector.

Patent document 1 discloses a lithium ion secondary battery having an angular case. Through holes are formed in the lid of the case. A rod like barrel portion is inserted into the through hole, one end portion of the barrel portion is connected to a first flange portion in the case and the other end portion of the barrel portion is connected to a terminal plate (external terminal). A tab of the electrode assembly is connected to the first flange portion.

### PRIOR ART DOCUMENT

### Patent Document

Patent Document 1: JP-A-2016-91659

### SUMMARY OF THE INVENTION

### Problems to be Solved by the Invention

An energy storage device is requested to exhibit favorable mechanical and electrical connecting properties between an external terminal and a current collector, favorable gas-tightness, and favorable property of preventing a leakage of an electrolyte solution from the energy storage device and intrusion of moisture into the energy storage device.

The present invention has been made in view of such circumstances, and it is an object of the present invention to provide an energy storage device and an energy storage module which exhibits favorable gas-tightness and can prevent a leakage of an electrolyte solution from the energy storage device and intrusion of moisture into the energy storage device.

### Means for Solving the Problems

An energy storage device and an energy storage module according to the present invention respectively include: an outer case on which an external terminal is mounted; an electrode assembly housed in the outer case; a conductive shaft portion having one end thereof connected to the external terminal; and a conductive plate portion housed in the outer case, to which the other end of the conductive shaft portion is connected, and the electrode assembly is connected, wherein the external terminal is configured such that a recessed portion is formed on a first surface of the external terminal on which a bus bar is placed, and a second surface of the external terminal opposedly faces the outer case, one end of the conductive shaft portion is brought into pressure contact with the external terminal in an inside of the recessed portion, and the recessed portion formed on the external terminal is gas-tightly covered by the bus bar.

### Advantages of the Invention

According to the energy storage device and the energy storage module of the present invention, the recessed portion is formed on the first surface of the external terminal, and the recessed portion is gas-tightly covered by the bus bar and hence, a pressure contact portion between the external terminal and the conductive shaft portion is isolated from the outside. Accordingly, the energy storage device and the energy storage module of the present invention can acquire favorable corrosion resistance, and can suppress the lowering of electric performance of the energy storage device and shortening of lifetime of the energy storage device.

### BRIEF DESCRIPTION OF THE DRAWINGS

FIG. 1 is a schematic perspective view of an energy storage device.

FIG. 2 is a schematic front view of the energy storage device.

FIG. 3 is a schematic cross-sectional view of the energy storage device taken along line III-III in FIG. 2.

FIG. 4 is a partially enlarged cross-sectional view of a portion of the energy storage device in the vicinity of a lid plate taken along line IV-IV in FIG. 2.

FIG. 5 is a schematic view of an energy storage module including a plurality of energy storage devices.

FIG. 6 is a partially-enlarged cross-sectional view of a portion of the energy storage device taken along line VI-VI in FIG. 5.

### MODE FOR CARRYING OUT THE INVENTION

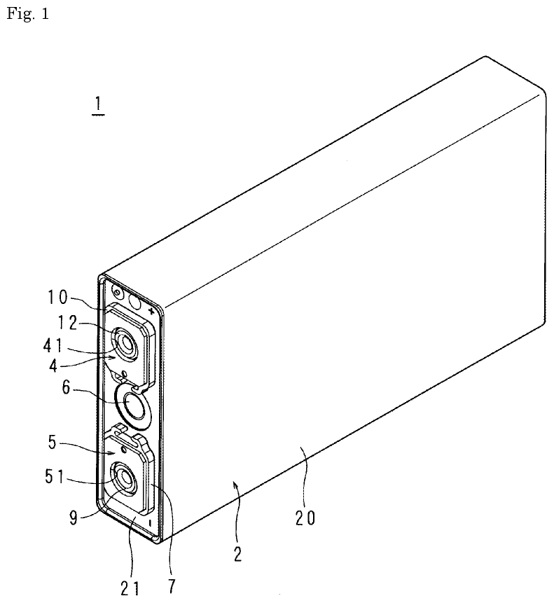

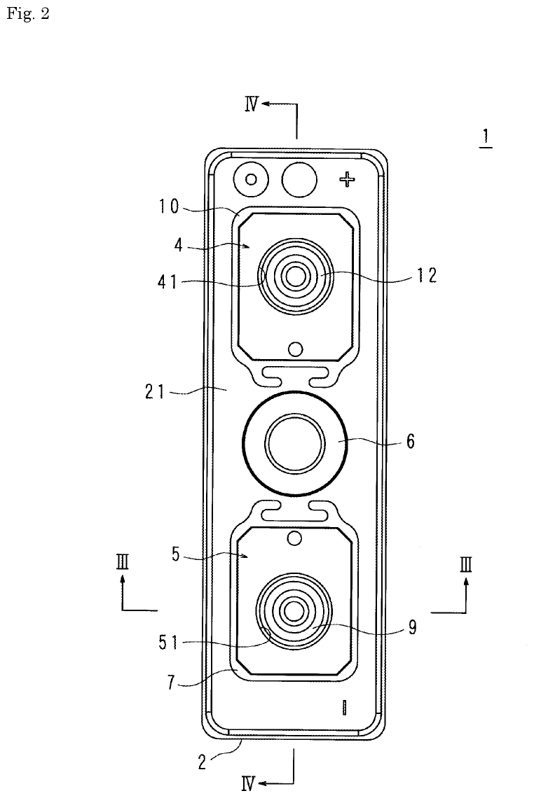

Hereinafter, the present invention is described with reference to drawings showing an energy storage device and an energy storage module according to an embodiment. FIG. 1 is a schematic perspective view of the energy storage device, and FIG. 2 is a schematic front view of the energy storage device. Hereinafter, the description is made with respect to a case where the energy storage device 1 is a lithium ion secondary battery. However, the energy storage device 1 is not limited to a lithium ion secondary battery.

As shown in FIG. 1, the energy storage device 1 includes: a case 2 (outer case) having a lid plate 21 and a case body 20; a positive electrode terminal 4 (external terminal); a negative electrode terminal 5 (external terminal); outer gaskets 7, 10; a rupture valve 6, and current collectors 9, 12. The positive electrode terminal 4 has a recessed portion 41 at an approximately center portion thereof, and an end portion of the current collector 12 is mechanically and electrically connected to the recessed portion 41. The negative electrode terminal 5 has a recessed portion 51 at an approximately center portion thereof, and an end portion of the current collector 9 is mechanically and electrically connected to the recessed portion 51. The detailed connection structure of the current collectors 9, 12 is described later.

The case 2 is, for example, made of metal such as aluminum, an aluminum alloy, stainless steel or a synthetic resin. The case 2 has a rectangular parallelepiped shape, and accommodates the electrode assembly 3 described later, and an electrolyte solution (not shown in the drawing). In this embodiment, the lid plate 21 is disposed on a mounting surface of the energy storage device 1 (not shown in the drawing) in a vertically extending manner. The lid plate 21 may be disposed in an upwardly facing manner in FIG. 1.

As shown in FIG. 2, the positive electrode terminal 4 is disposed on one end portion of an outer surface of the lid plate 21 by way of the outer gasket 10, and the negative electrode terminal 5 is disposed on the other end portion of the outer surface of the lid plate 21 by way of the outer gasket 7. The positive electrode terminal 4 and the negative electrode terminal 5 are respectively configured such that a flat outer surface of the electrode terminal is exposed, and a conductive member such as a bus bar (not shown in the drawing) is welded to the outer surface. The rupture valve 6 is disposed between the positive electrode terminal 4 and the negative electrode terminal 5 formed on the lid plate 21.

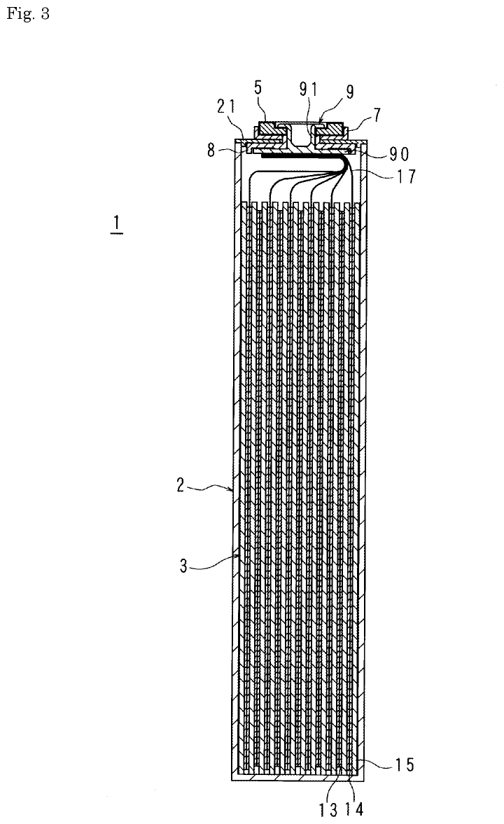

FIG. 3 is a schematic cross-sectional view of the energy storage device 1 taken along line III-III in FIG. 2. As shown in FIG. 3, the electrode assembly 3 includes a plurality of positive electrode plates 13, a plurality of negative electrode plates 14, and a plurality of separators 15. The positive electrode plate 13, the negative electrode plate 14, and the separator 15 respectively have a rectangular shape as viewed in a lateral direction in FIG. 3. The plurality of positive electrode plates 13 and the plurality of negative electrode plates 14 are stacked such that the positive electrode plate 13 and the negative electrode plate 14 are alternately stacked with the separator 15 interposed between the positive electrode plate 13 and the negative electrode plate 14. FIG. 3 shows a state where negative electrode tabs 17 respectively extending from the negative electrode plates 14 are made to overlap with each other on a distal end side of the negative electrode plates 14, and are joined to an inner surface (second surface) of a conductive plate portion 90. The negative electrode tabs 17 are accommodated in the inside of the case 2 in a bent posture so as to enhance energy density of the energy storage device 1 (so as to make a space occupied by a current path between the negative electrode terminal 5 and the negative electrode plates 14 small). Although not shown in the drawing, positive electrode tabs 16 (described later) extending from the positive electrode plates 13 have the same configuration as the negative electrode tabs 17.

The electrode assembly 3 may be a winding type electrode assembly obtained by winding an elongated positive electrode plate 13 and an elongated negative electrode plate 14 with a separator 15 interposed between the positive electrode plate 13 and the negative electrode plate 14 in a flat shape. The mounting structure of the current collector 9 is described later.

The positive electrode plate 13 is obtained by forming a positive active material layer on both surfaces of a positive electrode substrate foil which is a plate-like (sheet-like) or an elongated strip-shaped metal foil made of aluminum, an aluminum alloy or the like. The negative electrode plate 14 is obtained by forming a negative active material layer on both surfaces of a negative electrode substrate foil which is a plate-like (sheet-like) or elongated strip-shaped metal foil made of copper, a copper alloy or the like.

As a positive active material used for forming the positive active material layer or as a negative active material used for forming the negative active material layer, a known material can be used provided that the positive active material and the negative active material can occlude and discharge lithium ions.

As the positive active material, for example, a polyanion compound such as LiMPO₄, LiM₂SiO₄, LiMBO₃ (M being one kind or two or more kinds of transition metal elements selected from a group consisting of Fe, Ni, Mn, Co and the like), a spinel compound such as lithium titanate or lithium manganate, lithium transition metal oxide such as LiMO₂ (M being one kind or two or more kinds of transition metal elements selected from a group consisting of Fe, Ni, Mn, Co and the like) or the like can be used.

As the negative active material, for example, besides lithium metal and a lithium alloy (lithium-aluminum, lithium-silicon, lithium-lead, lithium-tin, lithium-aluminum-tin, lithium-gallium, and a lithium metal containing alloy such as a wood alloy), an alloy which can occlude or discharge lithium ions, a carbon material (for example, graphite, hardly graphitizable carbon, easily graphitizable carbon, low-temperature sintered carbon, amorphous carbon or the like), metal oxide, lithium metal oxide (Li₄Ti₅O₁₂ or the like), a polyphosphoric acid compound and the like can be named.

The separator 15 is formed using a sheet-like or a film-like material into which an electrolyte solution infiltrates. As a material for forming the separator 15, for example, a woven fabric, a non-woven fabric, and a sheet-like or film-like microporous resin can be named. The separator 15 separates the positive electrode plate 13 and the negative electrode plate 14 from each other and, at the same time, holds an electrolyte solution between the positive electrode plate 13 and the negative electrode plate 14.

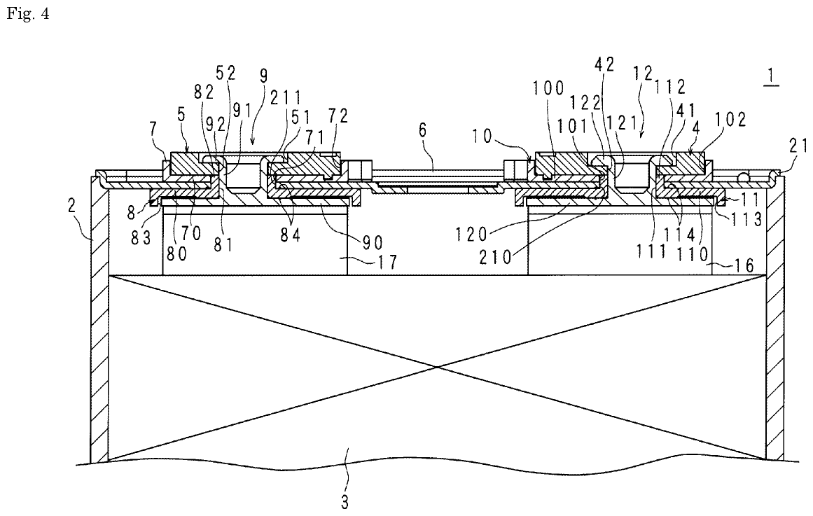

FIG. 4 is a partially-enlarged cross-sectional view of a portion of the energy storage device 1 in the vicinity of the lid plate 21 taken along line IV-IV in FIG. 2. Two through holes 210, 211 are formed in the lid plate 21 in a spaced apart manner in a longitudinal direction of the lid plate 21. The rupture valve 6 is disposed between the through holes 210, 211.

As shown in FIG. 4, the energy storage device 1 includes the negative electrode terminal 5, the outer gasket 7, an inner gasket 8, and the current collector 9 in the vicinity of the through hole 211.

The current collector 9 is made of copper, and includes the conductive plate portion 90, a conductive shaft portion 91, and a swaged portion 92. The conductive plate portion 90 is disposed inside the lid plate 21. The cylindrical conductive shaft portion 91 is disposed at an approximately center portion of an outer surface (first surface) of the conductive plate portion 90, and passes through the through hole 211. The swaged portion 92 is formed on one end of the conductive shaft portion 91 in an axial direction of the conductive shaft portion 91.

The conductive shaft portion 91 may be integrally formed with the conductive plate portion 90. Alternatively, the conductive shaft portion 91 may be formed as a body separate from the conductive plate portion 90 and may be joined to the conductive plate portion 90 by welding, swaging or the like. The conductive shaft portion 91 may be a solid portion.

The inner gasket 8 is made of a synthetic resin such as polyphenylene sulfide (PPS) or polypropylene (PP), for example. The inner gasket 8 has a plate portion 80, an insertion hole 81, a boss 82, an edge portion 83, and compressed convex portions 84. The plate portion 80 is interposed between the conductive plate portion 90 and an inner surface of the lid plate 21, and has the insertion hole 81 at an approximately center portion thereof. The cylindrical boss 82 is disposed so as to surround the insertion hole 81, and covers an outer periphery of the conductive shaft portion 91. On an peripheral edge of an inner surface of the plate portion 80, the edge portion 83 which protrudes inward is formed. The edge portion 83 covers a side surface of the conductive plate portion 90. On both surfaces of the plate portion 80 on an outer peripheral side of the boss 82, the ring-shaped compressed convex portion 84 is formed respectively. The compressed convex portion 84 is not limited to a ring shape, and a plurality of compressed convex portions 84 may be formed in a spaced apart manner in a circumferential direction. The compressed convex portions 84 are compressed by pressing at the time of swaging.

The negative electrode terminal 5 is made of aluminum, and has a rectangular plate shape. The negative electrode terminal 5 has a circular-hole-shaped recessed portion 51 on a first surface (outer surface) thereof. In a center portion of a bottom surface of the recessed portion 51, an insertion hole 52 (through hole) through which the conductive shaft portion 91 passes is formed.

The negative electrode terminal 5 is made of aluminum, and the swaged portion 92 is made of copper and hence, there is the large difference in ionization tendency between the negative electrode terminal 5 and the swaged portion 92. Assuming a case where a liquid such as water intrudes into the contact portion between the negative electrode terminal 5 and the swaged portion 92 so that the swaged portion 92 and the negative electrode terminal 5 become conductive with each other through the liquid, there is a concern that a galvanic action (galvanic corrosion) occurs.

The outer gasket 7 is made of a synthetic resin such as PPS or PP. The outer gasket 7 has a plate portion 70, an insertion hole 71, and an edge portion 72. The plate portion 70 is interposed between an outer surface of the lid plate 21 and an inner surface of the negative electrode terminal 5. The insertion hole 71 is formed at an approximately center portion of the plate portion 70, and the boss 82 is inserted into the insertion hole 71. On a peripheral edge of an outer surface of the plate portion 70, the edge portion 72 which protrudes outward is formed. The edge portion 72 covers a side surface of the negative electrode terminal 5.

Respective sizes (area) of the conductive plate portion 90 and the negative electrode tabs 17 in a planar direction (longitudinal direction) of the lid plate 21 are set larger than a size of the negative electrode terminal 5 in a planar direction (longitudinal direction) of the lid plate 21.

As shown in FIG. 4, the energy storage device 1 includes the positive electrode terminal 4, the outer gasket 10, an inner gasket 11, and the current collector 12 in the vicinity of the through hole 210.

The current collector 12 is made of aluminum, and includes a conductive plate portion 120, a conductive shaft portion 121, and a swaged portion 122. The conductive plate portion 120 is disposed inside the lid plate 21. The cylindrical conductive shaft portion 121 is disposed at an approximately center portion of the conductive plate portion 120, and passes through the through hole 210. The swaged portion 122 is formed on an end portion of the conductive shaft portion 121.

The conductive shaft portion 121 may be integrally formed with the conductive plate portion 120. Alternatively, the conductive shaft portion 121 may be formed as a body separate from the conductive plate portion 120 and may be joined to the conductive plate portion 120 by welding, swaging or the like.

The inner gasket 11 is made of a synthetic resin such as PPS or PP, for example. The inner gasket 11 has a plate portion 110, an insertion hole 111, a boss 112, an edge portion 113, and compressed convex portions 114. The plate portion 110 is interposed between the conductive plate portion 120 and the inner surface of the lid plate 21, and has the insertion hole 111 at an approximately center portion thereof. The cylindrical boss 112 is disposed so as to surround the insertion hole 111, and covers an outer periphery of the conductive shaft portion 121. On a peripheral edge of an inner surface of the plate portion 110, the edge portion 113 which protrudes inward is formed. On both surfaces of the plate portion 110 on an outer peripheral side of the boss 112, the ring-shaped compressed convex portion 114 is formed respectively. The compressed convex portion 114 is not limited to a ring shape, and a plurality of compressed convex portions 114 may be formed in a spaced apart manner in a circumferential direction.

The positive electrode terminal 4 is made of aluminum, and has a rectangular plate shape. The positive electrode terminal 4 has the circular-hole-shaped recessed portion 41 on a first surface (outer surface) thereof. In a center portion of a bottom surface of the recessed portion 41, an insertion hole 42 (through hole) into which the conductive shaft portion 121 is inserted is formed.

By swaging an end portion of the conductive shaft portion 121 to the recessed portion 41, the swaged portion 122 is formed so that the current collector 12 is mechanically and electrically connected to the positive electrode terminal 4. A plating layer is not formed on a surface of the positive electrode terminal 4. Both the positive electrode terminal 4 and the current collector 12 are made of aluminum and hence, a galvanic action does not occur at a portion where the swaged portion 122 and the positive electrode terminal 4 are brought into contact with each other.

The outer gasket 10 is made of a synthetic resin such as PPS or PP. The outer gasket 10 has a plate portion 100, an insertion hole 101, and an edge portion 102. The plate portion 100 is interposed between the outer surface of the lid plate 21 and an inner surface of the positive electrode terminal 4. The insertion hole 101 is formed at an approximately center portion of the plate portion 100, and the boss 112 is inserted into the insertion hole 101. On a peripheral edge of an outer surface of the plate portion 100, the edge portion 102 which protrudes outward is formed. The edge portion 102 covers a side surface of the positive electrode terminal 4.

In this embodiment, the negative electrode tabs 17 are disposed directly below the conductive shaft portion 91 and hence, a current path from the negative electrode tabs 17 to the negative electrode terminal 5 is short. The conducive plate portion 90 is formed into a plate shape extending substantially parallel to the lid plate 21 and hence, a volume which the conductive plate portion 90 occupies in the case 2 is small. Accordingly, volume occupancy of the electrode assembly 3 in the case 2 can be increased so that energy density of the energy storage device 1 can be enhanced. In spite of the fact that a volume which the conductive plate portion 90 occupies in the case 2 is small, the inner surface to which the negative electrode tabs 17 are connected can ensure a large area. Accordingly, by setting respective sizes of the conductive plate portion 90 and the negative electrode tabs 17 in a planar direction of the lid plate 21 larger than a size of the negative electrode terminal 5, a contact area between the negative electrode tabs 17 and the conductive plate portion 90 can be increased so that a resistance loss in a current path in the energy storage device can be reduced. In the same manner, a current path from the positive electrode tabs 16 to the positive electrode terminal 4 is shortened, and a contact area between the positive electrode tabs 16 and the conductive plate portion 120 is increased and hence, a resistance loss of a current path can be made small. Accordingly, even when a large current flows in the energy storage device 1, the current path is minimally fused.

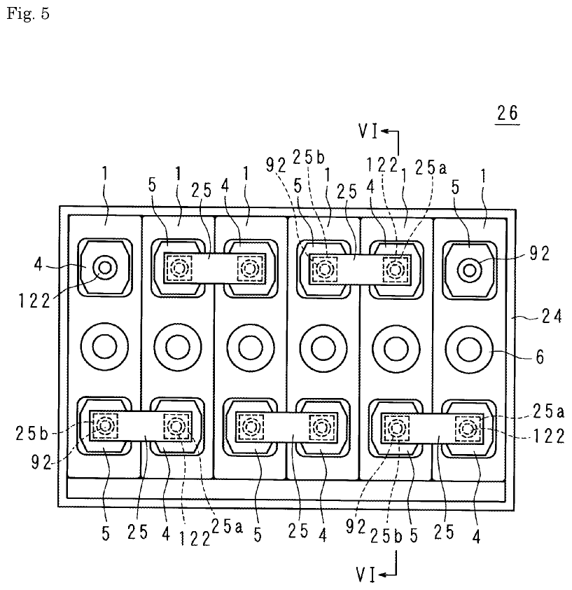

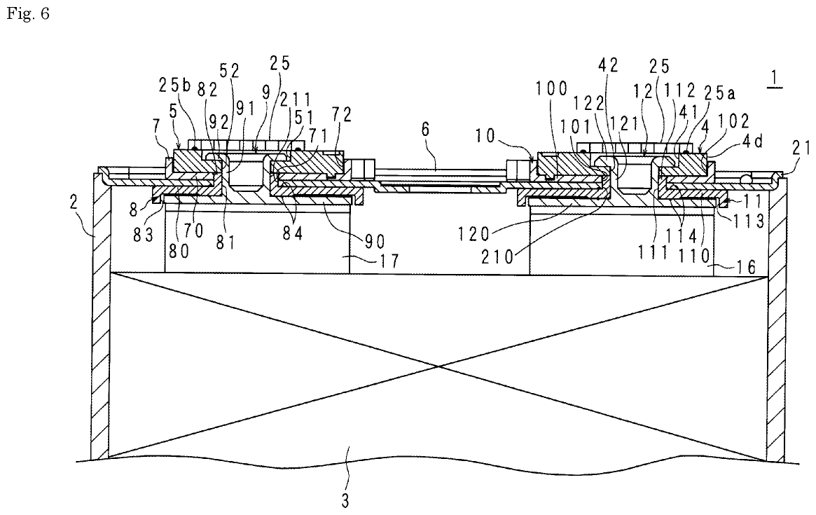

An energy storage module can be manufactured by using a plurality of energy storage devices 1. FIG. 5 is a schematic view of the energy storage module 26 which includes the plurality of energy storage devices 1, and FIG. 6 is a partially-enlarged cross-sectional view of a portion of the energy storage device 1 taken along line VI-VI shown in FIG. 5. The energy storage module 26 includes: a holder 24 such as a box and end plates; and the plurality of energy storage devices 1 which are held by the holder 24. The plurality of energy storage devices 1 are arranged such that walls on each of which external terminals are mounted are directed in the same direction. In this embodiment, the lid plates of the plurality of energy storage devices 1 are raised from a mounting surface, and the external terminals mounted on the lid plates are directed toward a side of the energy storage module. In the plurality of energy storage devices 1, the energy storage devices disposed adjacently to each other are disposed such that the positive electrode terminal 4 and the negative electrode terminal 5 of one energy storage device and the positive electrode terminal 4 and the negative electrode terminal 5 of the other energy storage device are disposed in an inverted manner in a vertical direction. By connecting the positive electrode terminal 4 of one energy storage device 1 and the negative electrode terminal 5 of the other energy storage device 1 disposed adjacently to one energy storage device 1 to each other using a bus bar 25, the plurality of energy storage devices 1 can be connected in series. The plurality of energy storage devices 1 may be connected parallel to each other by connecting the same poles.

The bus bar 25 has a rectangular shape, and one end portion of the bus bar 25 opposedly faces a connecting portion between the swaged portion 122 disposed in the inside of the recessed portion 41 and the positive electrode terminal 4, and covers the recessed portion 41. Over the whole periphery of the recessed portion 41, one end portion of the bus bar 25 and the positive electrode terminal 4 are welded to each other. Hereinafter, a welded portion between the bus bar 25 and the positive electrode terminal 4 is referred to as a welded portion 25a. The recessed portion 41 is sealed by one end portion of the bus bar 25 and the welded portion 25a, and the connecting portion between the swaged portion 122 disposed in the inside of the recessed portion 41 and the positive electrode terminal 4, that is, a pressure contact portion formed by swaging is isolated from the outside.

The other end portion of the bus bar 25 opposedly faces a connecting portion between the swaged portion 92 disposed in the inside of the recessed portion 51 and the negative electrode terminal 5, and covers the recessed portion 51. Over the whole periphery of the recessed portion 51, the other end portion of the bus bar 25 and the negative electrode terminal 5 are welded to each other. Hereinafter, a welded portion between the bus bar 25 and the negative electrode terminal 5 is referred to as a welded portion 25b. The recessed portion 51 is sealed by the other end portion of the bus bar 25 and the welded portion 25b, and the connecting portion between the swaged portion 92 disposed in the inside of the recessed portion 51 and the negative electrode terminal 5, that is, a pressure contact portion is isolated from the outside.

The connecting portion between the positive electrode terminal 4 and the swaged portion 122 or the connecting portion between the negative electrode terminal 5 and the swaged portion 92, that is, the pressure contact portion is welded to the bus bar 25 over the whole periphery thereof and hence, the recessed portion 41, 51 is gas-tightly covered by the bus bar 25, and is isolated from the outside. Accordingly, it is possible to prevent the occurrence of a galvanic corrosion on the pressure contact portion caused by a reaction with moisture or salt contained in outside air, for example. Further, it is possible to prevent a leakage of an electrolyte solution from the energy storage device 1 and intrusion of moisture into the energy storage device 1. Welding is merely one example for realizing gas-tight sealing, and the whole periphery of the connecting portion between the positive electrode terminal 4 and the swaged portion 122 or the whole periphery of the connecting portion between the negative electrode terminal 5 and the swaged portion 92 and the bus bar 25 may be sealed by using an adhesive agent, a seal ring or the like, for example.

A copper member is used as the current collector 9, and an aluminum member is used as the negative electrode terminal 5. The difference in ionization tendency between copper and aluminum is relatively large and hence, when a contact portion between copper and aluminum is exposed to outside air, galvanic corrosion is liable to occur due to moisture or salt contained in outside air. As a countermeasure against galvanic corrosion, applying of nickel plating to the current collector 9 is considered. However, when the negative electrode tabs 17 and the conductive plate portion 90 are welded to each other by ultrasonic welding, there is a concern that a nickel plating is peeled off so that nickel powder is mixed into the negative electrode tabs 17.

As a countermeasure against galvanic corrosion, applying of nickel plating only to the conductive shaft portion 91 without applying nickel plating to the conductive plate portion 90 is also considered. However, when the conductive shaft portion 91 and the conductive plate portion 90 are integrally formed with each other, applying of nickel plating only to the conductive shaft portion 91 is difficult. In this embodiment, the occurrence of galvanic corrosion is prevented without applying nickel plating. A member used for forming the current collector 9 is not limited to a copper member, and a member used for forming the negative electrode terminal 5 is not limited to an aluminum member.

The description has been made with respect to the case where the energy storage device 1 is a lithium ion secondary battery. However, the energy storage device 1 is not limited to the lithium ion secondary battery. The energy storage device 1 may be other secondary batteries such as a nickel hydrogen battery, may be a primary battery, or may be an electrochemical cell such as a capacitor.

The embodiment disclosed herein is illustrative in all aspects and is not construed to limit the present invention. The technical features described in the embodiment can be combined with each other, and the scope of the present invention is intended to include all modifications within the claims and range of equivalency of the claims.

### DESCRIPTION OF REFERENCE SIGNS

1: energy storage device

2: case

3: electrode assembly

4: positive electrode terminal (external terminal)

41: recessed portion

42: insertion hole (through hole)

5: negative electrode terminal (external terminal)

51: recessed portion

52: insertion hole (through hole)

9, 12: current collector

90, 120: conductive plate portion

91, 121: conductive shaft portion

92, 122: swaged portion

21: lid plate

25: bus bar

25a, 25b: welded portion

26: energy storage module

1. An energy storage device comprising:
an outer case on which an external terminal is mounted;
an electrode assembly housed in the outer case;
a conductive shaft portion having one end thereof connected to the external terminal; and
a conductive plate portion housed in the outer case, to which the other end of the conductive shaft portion is connected, and the electrode assembly is connected,
wherein the external terminal is configured such that a recessed portion is formed on a first surface of the external terminal on which a bus bar is placed, and a second surface of the external terminal opposedly faces the outer case,
one end of the conductive shaft portion is brought into pressure contact with the external terminal in an inside of the recessed portion, and
the recessed portion formed on the external terminal is gas-tightly covered by the bus bar.

2. The energy storage device according to claim 1, wherein the conductive plate portion is formed in a plate shape extending substantially parallel to a lid plate of the outer case, has a first surface to which the other end of the conductive shaft portion is connected, has a second surface to which a tab of the electrode assembly extending toward the lid plate is connected, wherein a size of the conductive plate portion and a size of the tab in a planar direction of the lid plate are set larger than a size of the external terminal in the planar direction of the lid plate.

3. The energy storage device according to claim 1, wherein the conductive shaft portion is formed using a material different from a material for forming the external terminal.

4. The energy storage device according to claim 1, wherein
a through hole which is communicated with the recessed portion is formed in the external terminal, and
one end of the conductive shaft portion is inserted into the through hole and is swaged in the inside of the recessed portion.

5. The energy storage device according to claim 1, wherein
the conductive shaft portion has a copper member, and
the external terminal has an aluminum member.

6. An energy storage module comprising:
the energy storage device according to claim 1; and
a bus bar,
wherein the bus bar is welded to a periphery of the recessed portion of the external terminal.
